(19) United States
(12) Patent Application Publication
(10) Pub. No.: US 2008/0143272 A1
(43) Pub. Date: Jun. 19, 2008

(54) LIGHT WITH DIMMER

(75) Inventors: Brendan Patrick Byrne, Germantown, TN (US); Donald Wilcher, Collierville, TN (US)

Correspondence Address: BAKER, DONELSON, BEARMAN, CALDWELL & BERKOWITZ, SIX CONCOURSE PARKWAY, SUITE 3100, ATLANTA, GA, 30328, US

(73) Assignee: Hunter Fan Company

(21) Appl. No.: 11/951,385

(22) Filed: Dec. 6, 2007

Related U.S. Application Data
(60) Provisional application No. 60/875,324, filed on Dec. 16, 2006.

(51) Int. Cl. H05B 39/04

(52) U.S. Cl. 315/291

(57) ABSTRACT

A light or light kit (10) is disclosed which includes a switch housing (11, a plurality of light sockets (12), and a pull chain type switch (13) which includes a pull chain or cord (13′). A light bulb (15) is mounted within each light socket. The light kit also includes a controller or dimmer module (17) electrically coupled between the pull chain switch and the light socket. The dimmer module may gradually change the light intensity with the actuation of the pull chain switch through the continual pulling of the pull chain.

### REFERENCE TO RELATED APPLICATION

Applicant claims the benefit of U.S. Provisional Patent Application Ser. No. 60/875,324 filed Dec. 16, 2006.

### TECHNICAL FIELD

This invention relates to a light and dimmer, and particularly a dimmer for a light having a pull chain to actuate the dimming of the light.

### BACKGROUND OF THE INVENTION

Light fixtures have existed for many years. Some light fixtures are coupled to ceiling fans, sometimes referred to as ceiling fan light kits. Many of these lights and light kits have an on/off switch which is actuated by a pull cord or chain, the terms cord, chain, line or similar structure may be used collectively herein as chain. The pulling movement on the pull chain changes turns the light switch from an on position to an off position, or visa-versa. As such, the light is either fully illuminated or off.

It is seen that a need exists for a light that can have several illumination intensities but which may also be actuated manually. It is to the provision of such therefore that the present invention is primarily directed.

### BRIEF DESCRIPTION OF THE DRAWING

FIG. 1 is a side view of a ceiling fan including a light that embodies principles of the invention in a preferred form.

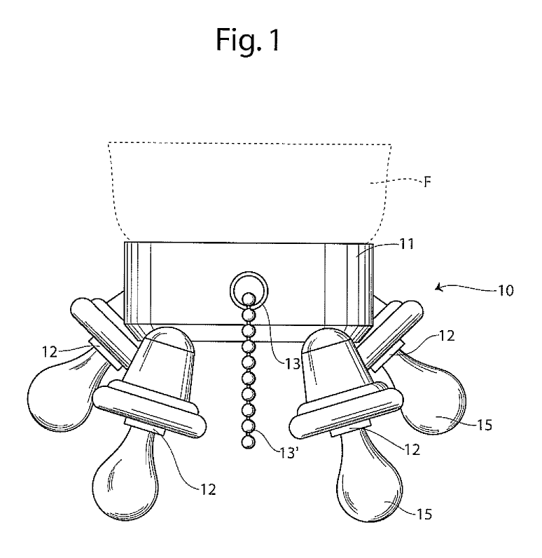

FIG. 2 is a block diagram of the electric circuit of the light of FIG. 1.

FIG. 3 is a circuit diagram of the light of FIG. 1.

### DETAILED DESCRIPTION

With reference next to the drawings, there is shown a light or light kit 10 in a preferred form of the invention. The light 10 includes a switch housing 11 shown coupled to a series of four light sockets 12, although the number of light sockets may vary, and a pull chain type switch 13 which includes a pull chain or cord 13′. A light bulb 15 is mounted within each light socket 12. The pull chain switch 13 may be a single pole-single throw switch responsible for turning on and off the light bulbs 15 through the control of current thereto. The light kit 10 also includes a controller or dimmer module 17 electrically coupled between the pull chain switch 13 and the light socket 12.

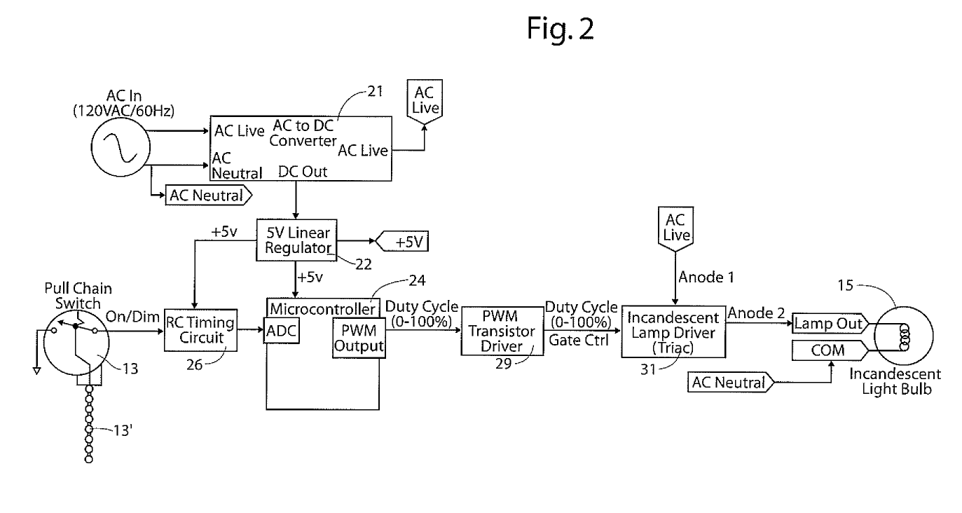

As best shown in FIG. 2, the light dimmer module 14 includes an AC to DC converter 21 electrically coupleable to a source of conventional AC household current. The converter 21 converts a 120 VAC input current to a 12 VDC output current. The circuit should have good thermal management of its full-wave bridge rectifier circuit and supporting power electronic components. The converter 21 is coupled to a 5 volt linear regulator 22 that is capable of stepping down the 12 VDC input current to a regulated +5 VDC output. The regulator 22 is coupled to a microcontroller 24, such as a NEC UPD78F9200 model, made by NEC Corporation of America of Irving, Tex. This microcontroller is an 8 bit microcontroller used for processing the pull chain switch 13 input control signal and providing output pulse width modulation (PWM)/duty cycle signals for the level of illumination or dimming mode. The microcontroller 24 is coupled to the pull chain switch 13 through a RC timing circuit 26. The timing circuit 26 is a resistor-capacitor timing circuit which provides a time delay for the pull chain switch 13, thereby establishing a dimming mode initiated function.

The output of the microcontroller 24 is coupled to a pulse with modulation transistor driver 29, which is essentially a general purpose negative, positive, negative transistor used for assuring the proper squarewave current and voltage level is sufficient for dimming control of an incandescent lamp triac driver subcircuit 31 coupled thereto. The subcircuit 31 is used for the continuous on or dimming illumination level control of the light bulbs through the power level provided to the light socket. The subcircuit may be a BTA08B triac made by ST Microelectronics of Geneva, Switzerland.

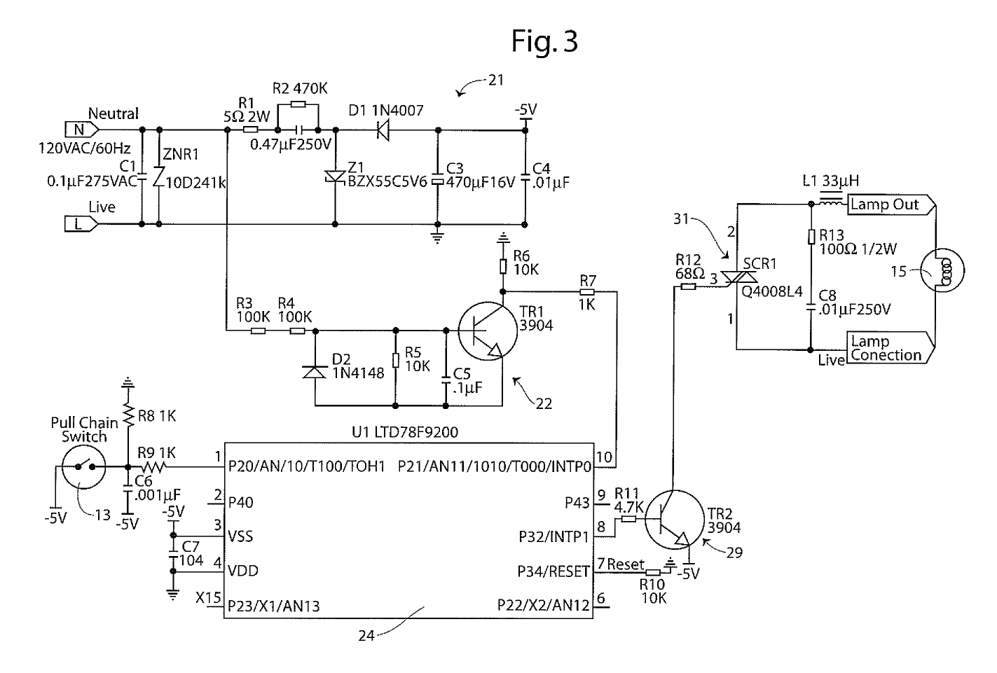

FIG. 3 shows a circuit diagram of the components described in reference to FIG. 2.

In use, the actuation of the pull chain 11′ places the switch 11 in a fully illuminated position. If the pull chain 11′ is given a firm pull and quick release the light module immediately turns the power to the light bulbs off. However, if the pull chain 11′ is given a firm pull and maintained in a pulled down position, i.e., sustained actuation or continually pulled down from its initially illuminated position, the light levels or intensities will gradually or incrementally decrease. The term incrementally is intend to denote either a decrease in a series of discernable increments or a smooth or continuous transition of illumination decrease.

The process of turning the power immediately off or gradually dimming the light intensity is controlled through the timing circuit 26, wherein the timing circuit senses the quick release to initiate an immediately turning off of the power or the continual pulling action to initiate a gradual dimming.

The electronic circuit has a memory feature within the microcontroller, wherein once a light intensity is selected, a recycling of the power (on/off) will return the dimming circuit to the previously selected light intensity.

It should be understood that the dimmer may also be designed to gradually increase the light intensity rather than deceasing the light intensity. As such, the dimmer may change the light intensity in either manner.

It should also be understood that the dimmer circuitry may be designed in a variety of manners known to one of ordinary skill in the art of electronics, and is not limited to the specific embodiment shown in the drawings.

It should also be understood that the light may be designed as a stand alone light or a light designed to be coupled to a ceiling fan F or other object.

It thus is seen that a light dimmer for a light or light kit having a pull chain is now provided. While this invention has been described in detail with particular references to the preferred embodiments thereof, it should be understood that many modifications, additions and deletions, in addition to those expressly recited, may be made thereto without departure from the spirit and scope of the invention as described by the following claims.

1. A light comprising,
a housing;
at least one light socket coupled to said housing;
a dimmer coupled to said light socket, said dimmer circuit including a pull chain, a pull chain switch coupled to said pull chain, and a dimming circuit coupled to said pull chain switch and mounted within said housing,
whereby the actuation of the pull chain causes the pull chain switch to actuate the dimming circuit to reduce power to the light socket.

2. The light of claim 1 wherein said dimming circuit includes a microcontroller having memory capabilities able to store a select power level,
whereby should the dimming circuit turn the power to the socket off, a subsequent actuation of the pull chain switch returns the power level to the select power level.

3. The light of claim 1 wherein said dimming circuit includes a timing circuit capable of immediately turning the power to said light socket off if the timing circuit senses a first type of actuation of the pull chain switch and gradually turning the power to the light socket off if the timing circuit senses a second type of actuation of the pull chain switch.

4. The light of claim 3 wherein said dimming circuit includes a microcontroller having memory capabilities able to store a select power level,
whereby should the dimming circuit turn the power to the socket off, a subsequent actuation of the pull chain switch returns the power level to the select power level.

5. The light of claim 1 wherein said housing is adapted to mate with a ceiling fan.

6. A light comprising,
a housing;
at least one light socket coupled to said housing;
a light bulb coupled to said at least one light socket;
a pull chain switch;
a pull chain coupled to said pull chain switch;
control means coupled to said pull chain switch for controlling the illumination intensity of said light bulb, said control means incrementally changing the illumination intensity of said light bulb with the sustained actuation of said pull chain switch.

7. The light of claim 6 wherein said control means includes a microcontroller having memory capabilities able to store a select power level,
whereby should the control means turn the power to the socket off, a subsequent actuation of the pull chain switch returns the power level to the select power level.

8. The light of claim 6 wherein said control means includes a timing circuit capable of immediately turning the power to said light socket off if the control means senses a first type of actuation of the pull chain switch and gradually turning the power to the light socket off if the control means senses a second type of actuation of the pull chain switch.

9. The light of claim 8 wherein said control means includes a microcontroller having memory capabilities able to store a select power level,
whereby should the control means turn the power to the socket off, a subsequent actuation of the pull chain switch returns the power level to the select power level.

10. The light of claim 6 wherein said housing is adapted to mate with a ceiling fan.
